(19) United States
(12) Patent Application Publication
(10) Pub. No.: US 2025/0018851 A1
(43) Pub. Date: Jan. 16, 2025

(54) SPORT SIMULATION SYSTEM

(71) Applicant: Mobile Mulligans LLC, Cary, NC (US)

(72) Inventor: Alex Todd, Cary, NC (US)

(73) Assignee: Mobile Mulligans LLC, Cary, NC (US)

(21) Appl. No.: 18/769,888

(22) Filed: Jul. 11, 2024

Related U.S. Application Data
(60) Provisional application No. 63/526,103, filed on Jul. 11, 2023.

(51) Int. Cl. B60P 3/025; A63B 24/00; A63B 71/04; A63B 71/06; B60P 1/64

(52) U.S. Cl. CPC B60P 3/025; A63B 71/04; B60P 1/6409; A63B 2024/0028; A63B 2071/0638; A63B 2225/11; B60Y 2200/142

(57) ABSTRACT

Sport simulation system. The present disclosure includes disclosure of a sport simulation system, including a box truck comprising a box, a driver-side fold-out configured to extend laterally from the box on a first side, and a passenger-side fold-out configured to extend laterally from the box on a second side opposite the first side, wherein an interior of the box is configured as a sport simulator with a projection screen.

### PRIORITY

The present application is related to, and claims the priority benefit of, U.S. Provisional Patent Application Ser. No. 63/526,103, filed Jul. 11, 2023, the contents of which are incorporated herein directly and by reference in their entirety.

### BRIEF SUMMARY

The present disclosure includes disclosure of a sport simulation system, comprising a box truck comprising a box, a driver-side fold-out configured to extend laterally from the box on a first side, and a passenger-side fold-out configured to extend laterally from the box on a second side opposite the first side, wherein an interior of the box is configured as a sport simulator with a projection screen.

The present disclosure includes disclosure of a sport simulation system, further comprising a retractable canopy configured to extend outward from a rear of the box.

The present disclosure includes disclosure of a sport simulation system, further comprising a rear platform extending outward from a rear of the box, the rear platform accessible from a ground by way of stairs.

The present disclosure includes disclosure of a sport simulation system, further comprising one or more bar tops coupled to the rear platform.

The present disclosure includes disclosure of a sport simulation system, further comprising a plurality of actuators extending downward from the box truck and configured to level or otherwise manipulate an angle of the box of the box truck.

The present disclosure includes disclosure of a sport simulation system, further comprising a smart hub configured to control operation of the plurality of actuators and further configured to control operation of the projection screen.

The present disclosure includes disclosure of a sport simulation system, further comprising a first projector coupled to an internal floor of the box, the first projector configured to project a first image onto the projection screen.

The present disclosure includes disclosure of a sport simulation system, further comprising a second projector coupled to an internal floor of the box, the second projector configured to project a second image onto a second projection screen in a direction opposite the projection of the first image onto the projection screen.

The present disclosure includes disclosure of a sport simulation system, comprising a ball tracking device coupled to an internal ceiling of the box, the ball tracking device configured to detect a speed and an angle of a ball hit toward the projection screen.

The present disclosure includes disclosure of a sport simulation system, wherein the driver-side fold-out and the passenger-side fold-out each comprise an upper extension panel and a lower extension panel, wherein the upper extension panel forms an extended ceiling for the box of box truck, and wherein the lower extension panel forms an extended floor for the box of the box truck.

The present disclosure includes disclosure of a sport simulation system, wherein the driver-side fold-out and the passenger-side fold-out each comprise a front panel and a rear panel, each configured to fold upward from the lower extension panel.

The present disclosure includes disclosure of a sport simulation system, wherein the box of the box truck comprises an upper box portion configured to extend upward to increase an internal height of the box.

The present disclosure includes disclosure of a sport simulation system, further comprising an impact screen positioned in front of or behind the projection screen.

The present disclosure includes disclosure of a sport simulation system, wherein the impact screen and the projection screen are integrated with the upper extension panel and the lower extension panel.

The present disclosure includes disclosure of a sport simulation system, further comprising a first projector coupled to an internal floor of the box, the first projector configured as a multi-layer projector configured to project a multi-layer image onto the projection screen.

The present disclosure includes disclosure of a sport simulation system, wherein at least one internal wall of the box of the box truck has impact padding applied thereto.

The present disclosure includes disclosure of a sport simulation system, as shown and/or described herein.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1A shows a top view of an exemplary sport simulation system, according to at least one embodiment of the present disclosure.

FIG. 1B shows a component block diagram of components of an exemplary sport simulation system, according to at least one embodiment of the present disclosure.

FIG. 2 shows a front perspective view of an exemplary sport simulation system, according to at least one embodiment of the present disclosure.

FIG. 3A shows a driver-side side view of an exemplary sport simulation system, according to at least one embodiment of the present disclosure.

FIG. 3B shows a component block diagram of components of an exemplary sport simulation system, according to at least one embodiment of the present disclosure.

FIG. 4 shows a rear perspective view of an exemplary sport simulation system, according to at least one embodiment of the present disclosure.

FIG. 5A shows a rear perspective view of an exemplary sport simulation system, according to at least one embodiment of the present disclosure.

FIG. 5B shows a component block diagram of components of an exemplary sport simulation system, according to at least one embodiment of the present disclosure.

FIG. 6 shows a rear perspective of an exemplary sport simulation system, according to at least one embodiment of the present disclosure.

FIG. 7 shows a front perspective view of an exemplary sport simulation system, according to at least one embodiment of the present disclosure.

FIG. 8 shows a front perspective view of an exemplary sport simulation system, according to at least one embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of a sport simulation system, comprising a box truck 104 with the box 102 (the storage compartment) modified for the purposes of simulated sport play, such as golf, baseball, softball, frisbee golf, and other sport play.

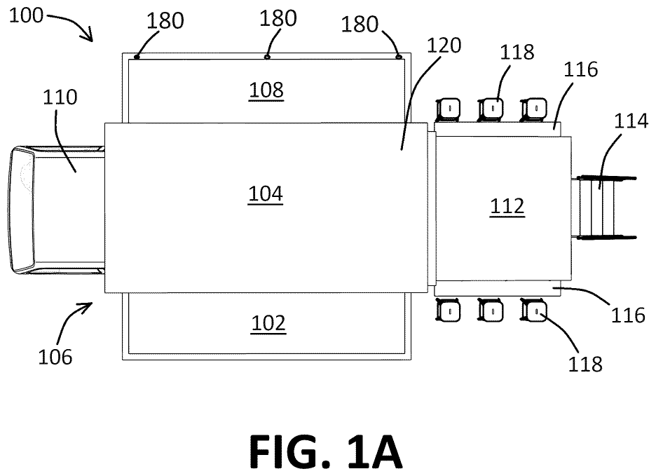

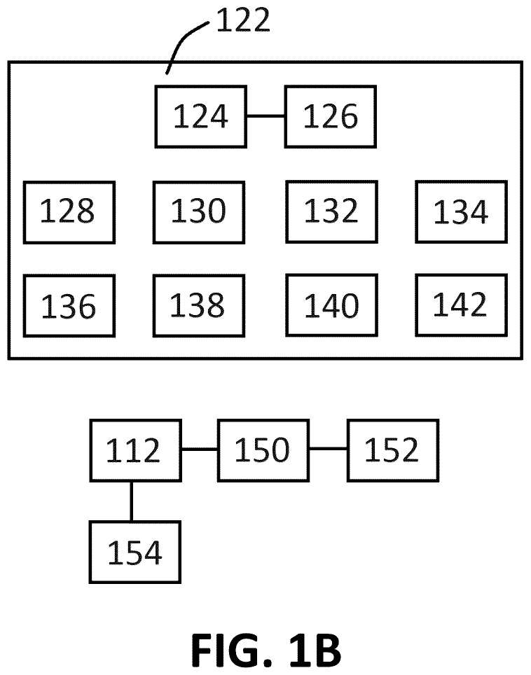

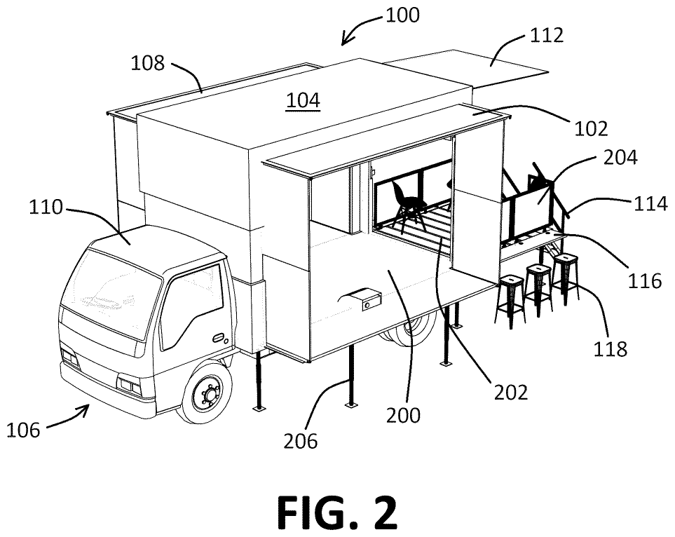

FIG. 1A shows a top view of an exemplary sport simulation system 100 of the present disclosure. As shown therein, a driver-side (road side) fold-out 102 is configured to extend laterally from the box 104 of a box truck 106. A passenger-side (median side) fold-out 108 is configured to extend laterally from box 104 of box truck, as shown in FIG. 1A. Box truck 106 itself has a cab section 110, the box 104, and a rear portion comprising a canopy 112 and a rear platform 202 (as shown in FIG. 2). Driver-side fold-out 102 and passenger-side fold-out 108 are shown as being extended outward from box 104 of box truck 106 in FIG. 1A. Fold-outs 102, 108 of the present disclosure can have any number of lengths, such as, for example, at or about 10′ long, 18′ long or smaller or larger. Fold-outs 102, 108 are configured to extend the usable space of the box 104 of box truck 106 and accommodate specific equipment or amenities.

Exemplary sport simulation systems 100 of the present disclosure have any number of the following novel features. For example, exemplary systems 100 of the present disclosure have a box 104 with a top 120 that can expand to achieve different interior heights ranging from 9 to 10 feet, for example. The expanding top 120 of box 104 can utilize an operative system 122 comprising a telescoping hydraulic mechanism 124, powered by a power source 126 (a generator, battery, or capacitor, for example), such as shown in the block component diagram of FIG. 1B, and operated from the exterior of the truck 106. The box 104, affixed to the chassis of the vehicle (box truck 106), can have a low ‘in transit’ height, such as between 8′2″ and 8′8″, and can be hydraulically expanded to an interior height at rest between 9′10″ and 10′, for example. Safety features of operative system can include hydraulic safety valves 128, mechanical locks 130, limit switches 132, position sensors 134, manual override controls 136, warning systems 138, interlock systems 140, load holding valves 142, and maintenance protocols 144 to prevent accidental closure or malfunction and ensure safe operation.

In various embodiments of systems 100 of the present disclosure, the sides (driver-side fold-out 102 and passenger-side fold-out 108 of box 104 can fold out to achieve an interior depth of 15′ to 15′6″, or even as deep as 20′ in various embodiments, for example.

FIG. 2 shows a perspective view of an exemplary sport simulation system 100 of the present disclosure. As shown therein, fold-outs 102, 108 are extended from box 104 of box truck 106 to increase the overall size of the effective internal floor 200 of box 104. Retractable canopy 112 is configured to provide shade to guests or create a VIP area, for example, offering a versatile and adjustable outdoor space. Canopy 112 can at least partially cover a rear platform 202, such as shown in FIG. 2, that can have stairs 114 extending therefrom to provide access to rear platform from the ground. In at least some embodiments, rear platform 202 is configured to move up and down so that, for example, participants in wheelchairs or those who would prefer not to use stairs 114 can step on rear platform 202 while on the ground and be raised up to the relative floor of the box 104 of box truck 106. Powered awnings (exemplary canopies 112) can exist at the rear and sides of box 104 of box truck 106. The powered awnings (exemplary canopies 112) can be made from durable, weather-resistant materials such as UV-protected vinyl or acrylic fabric, with frames constructed from lightweight but sturdy aluminum or steel. The extension and retraction mechanisms 150 of canopies 112 use electric motors 152, such as shown in the component block diagram of FIG. 1B, can be controlled by the smart hub 312 interface. Additional features include weather sensors 154 for automatic retraction in adverse conditions, providing durability and ease of use.

Rear platform 202 can have one or more bar tops 116 integrated therein, such as extending from one or both sides or the back of rear platform 202. One or more chairs or stools 118 can be positioned at or near bar tops 116 to provide for seating to use the same. One or more sidewalls 204, such as shown in FIG. 2, can also be coupled to rear platform 202 to prevent people from falling off platform 202.

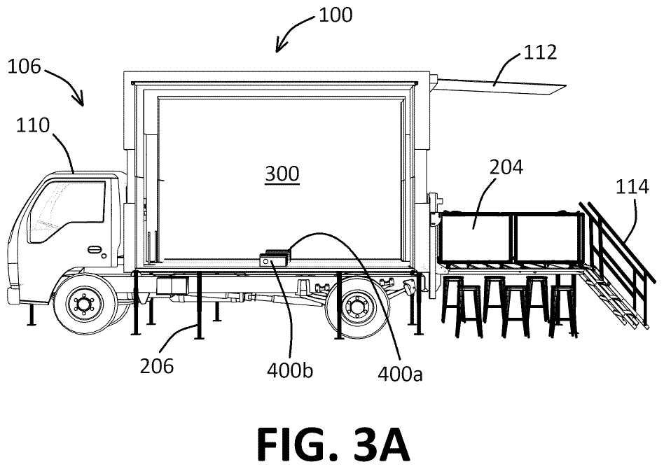

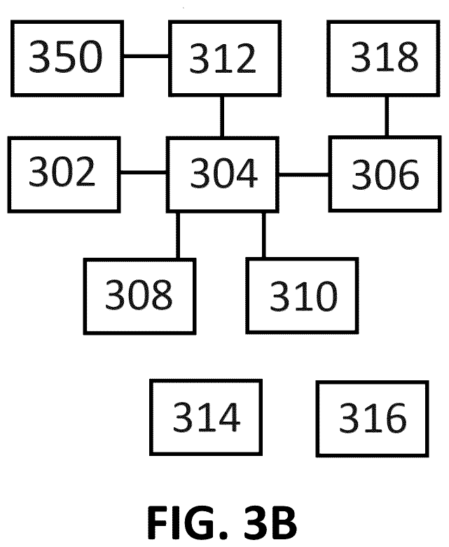

FIG. 2 also shows a plurality of fully powered actuators 204, situated below the box 204 and below fold-out 102, to enable leveling or manipulation of the surface inside the truck, offering flexibility and adaptability to accommodate user preferences. Actuators 204 can also be positioned below the cab section 110 of box truck 106 as well as below fold-out 108, such as shown in FIG. 3A.

FIG. 3A shows a side view of an exemplary sport simulation system 100 of the present disclosure. As shown therein, system 100 comprises a projector screen 300 configured to display an image of at least part of a golf course, baseball or softball field, and the like. Players (users of system 100) could then hit golf balls or baseballs toward projector screen 300 while playing simulated golf or baseball, for example, and system 100 would simulate the flight and landing of said balls while also providing statistics such as distance, apex, and the like. Projector screens 300 can be positioned along either side of box 104 and/or at a front of box 104, so to have one, two, or three projector screens 300 operable at any given time.

Regarding the retractable impact screens 302, and as shown in the block diagram in FIG. 3B, a motorized roller mechanism 303 can be used, which can comprise a high-torque electric motor 304 connected to a roller tube 306. The impact screens 302 are attached to the roller tube 306, which allows them to be smoothly rolled up or down. The roller mechanism 303 is powered by the truck's electrical system 308, with options for an onboard battery or an auxiliary power unit (APU) 310 to ensure continuous operation. A smart hub interface 312 controls the motorized rollers. Users can deploy or retract the screens 302 using a touch screen 314 or remote control 316. Programmable settings allow for partial or full deployment, enabling customization of screen 302 positions. The control system includes safety mechanisms such as automatic stop functions if obstacles are detected during deployment or retraction. Manual override controls 318 allow users to operate the rollers in case of system failure.

Impact screens 302, as referenced herein, can be designed to be retractable, enhancing the versatility of the simulator space. When retracted, the screens 302 provide additional room for different activities or setups inside the box 104 of the truck 106. The system 100 supports interchangeable screen 302 materials for various simulation scenarios. Users can quickly swap out screens using ring anchor points 180 (such as D-Ring anchor points), such as shown in FIG. 1, and SEG (Silicone Edge Graphics) style vinyl fabrics, as may be desired. This allows for quick changes between high-impact, low-impact, and advertisement screens. D-Ring anchor points 180 on the top and bottom folding sides for external attachments. D-Ring anchor points 180 are strategically placed on the top and bottom folding sides of the truck, made from high-strength materials like stainless steel or reinforced aluminum. They support significant loads and accommodate various external attachments, such as interchangeable SEG style vinyl fabrics for advertisements, additional protective netting, or auxiliary equipment like portable lighting or speakers.

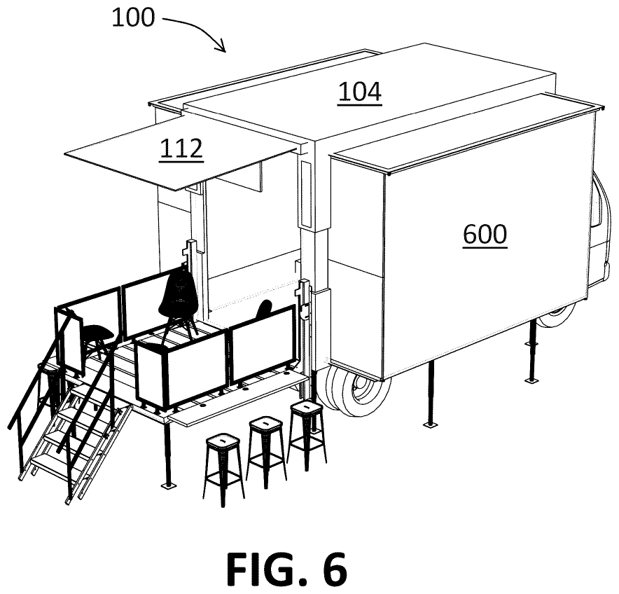

The setup, as referenced herein, can include multiple screens: the impact/projector screen 300 closest to the interior, and the rear projector screens 600 (as shown in FIG. 6) closest to the exterior. The rear projector screens 600 serve as secondary impact screens on the hitting side, providing added protection, and display images or videos on the opposite, non-hitting side.

The primary screen 300 can serve a dual purpose, such as functioning as both an impact screen 302 for golf or baseball (or other ball) shots and a projection screen for displaying simulation content. It is made from high-durability materials that can withstand repeated impacts while maintaining image clarity. These screens 300 can be designed for rear projection, allowing images to be projected from the inside and viewed from the outside. They also serve as secondary impact screens 302 on the hitting side, providing added protection. This dual functionality enhances both the visual appeal and safety of the simulator. A third screen can be retracted or attached to D-Ring anchor points for displaying SEG style vinyl fabrics. This screen provides additional space for advertisements or sponsor messages, adding commercial value to the setup.

A smart hub 312 interface allows for seamless control and management of the motorized roller mechanism and screen configurations. Users can easily switch between different screen setups and adjust the deployment settings. The system (smart hub 312) is designed for ease of use, with intuitive controls and visual guides to assist users in deploying and retracting screens. The interchangeable screen feature allows for quick and efficient changes between different simulation and advertisement scenarios.

All components of the motorized roller mechanism 303 and impact screens 302 are made from high-quality materials to ensure durability and longevity. The screens are resistant to wear and tear, and the motorized rollers are designed for continuous operation. The smart hub 312 interface includes maintenance alerts to notify users of any required maintenance or potential issues with the motorized rollers or screens. This proactive approach helps maintain optimal performance and reduce downtime.

The impact screens 302 can be adjusted to different angles and heights, providing users with the best possible viewing and hitting experience. The ability to switch between different screen types and configurations allows for a dynamic and engaging user experience, whether practicing golf shots or displaying advertisements, for example.

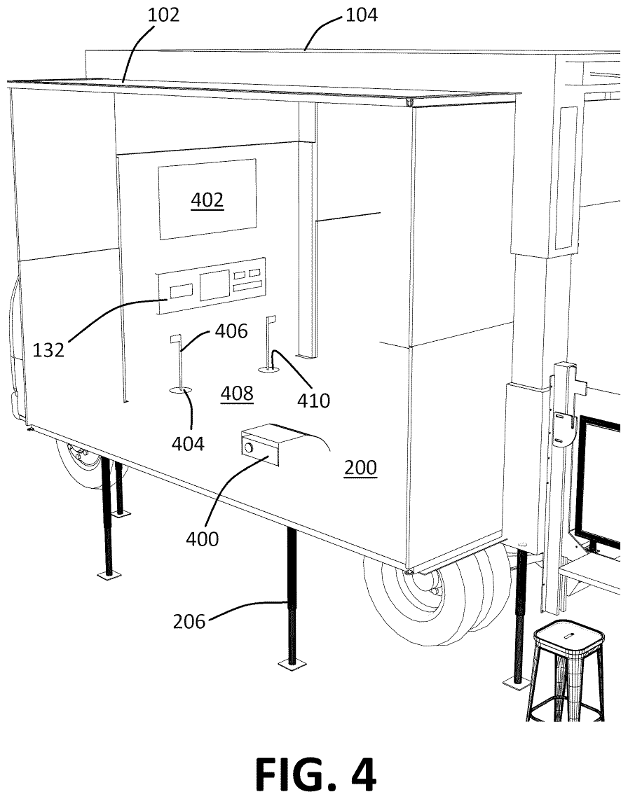

FIG. 4 shows a perspective view of an internal portion of an exemplary sport simulation system 100 of the present disclosure. As shown therein, a projector 400 is positioned on the internal floor 200 of the box 104 of box truck 106, configured to project an image onto a projection screen 300 (shown in FIG. 3A). FIG. 3A also shows two projectors 400 (a first projector 400a and a second projector 400b), directed in opposite directions so that one projector 400 (such as projector 400a) can project an image on a projection screen 300 positioned at a passenger-side of the box 104, while another projector 400 (such as projector 400b) can project an image on a projection screen positioned at a driver-side of the box 104. Exemplary embodiments of systems 100 of the present disclosure that use dual projectors 400a, 400b provides for an immersive experience, projecting different images on different screens 300. The dual projectors 400a, 400b can be synchronized with the simulator software (accessible from smart hub 312) to deliver a multi-screen 300 experience. This setup can display different views, such as the golfer's perspective and a top-down view of the course, enhancing realism and user engagement. The system can use advanced synchronization protocols (e.g., NTP, PTP), frame buffering, and timing mechanisms. High-resolution projectors 400a, 400b (at least 1920×1080 pixels or 4K), high brightness (3000 lumens), and high contrast ratios (100,000:1) can ensure image clarity. Additional features include rear projection screens 600 for exterior visibility and high-fidelity, surround sound audio for an immersive experience. Projectors 400 of the present disclosure can be coupled to an internal floor of the box 104, and can be configured as a multi-layer projector 400 configured to project a multi-layer image onto the projection screen 300.

FIG. 4 also shows the smart hub 312, such as being positioned on an internal wall of box 104 of box truck 106. Smart hub 312 can be operated as disclosed herein to control operation of projectors 400, screens 300, 600, simulated sport game play, actuators 206, and the like. A smart hub 312 can control powered accessories like the awning (canopy 112), television/monitor (display screen 402), and ball tracking device 500. The smart hub 312 features a user-friendly touch screen (display screen 402) interface, offering centralized control of all powered accessories. Connectivity options include Wi-Fi, Bluetooth, HDMI, USB-C, and other standard ports for seamless integration with various devices and projectors 400. Advanced features include voice control and remote access via mobile devices, enhancing convenience and operational efficiency.

A display screen 402 positioned relative to smart hub 312 can display a graphical user interface in connection with operation of smart hub 312. FIG. 4 also shows optional putting holes and flags 404 that can be integrated into box 104 of box truck 106 to allow for additional simulated golf game play. The integrated holes 404 are designed to simulate realistic putting scenarios, featuring high-quality, durable materials such as synthetic turf 408 and plastic or metal cups. The flag sticks 406 are made from lightweight but sturdy materials like fiberglass or aluminum. Additional features include adjustable hole 404 positions and integrated feedback systems, such as sensors 410 that detect when a ball enters the hole, providing instant feedback to enhance the training experience.

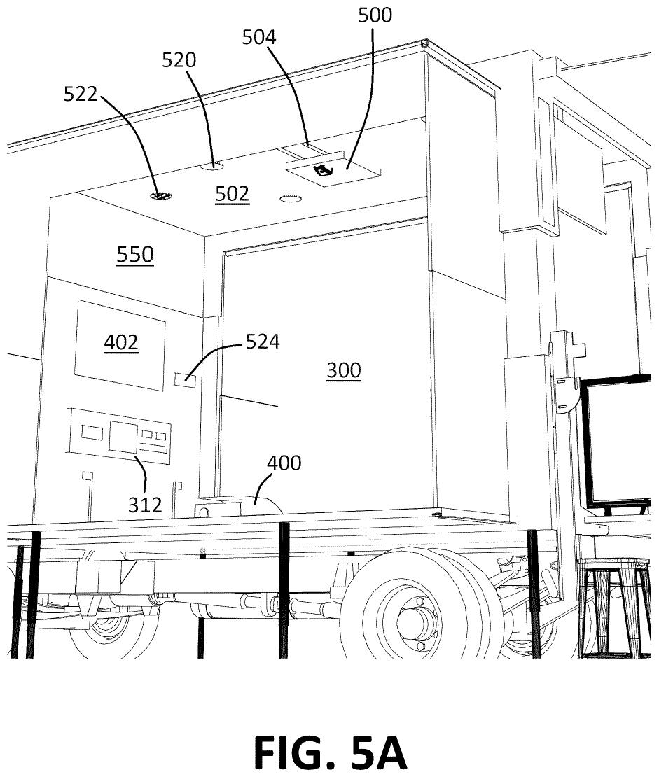

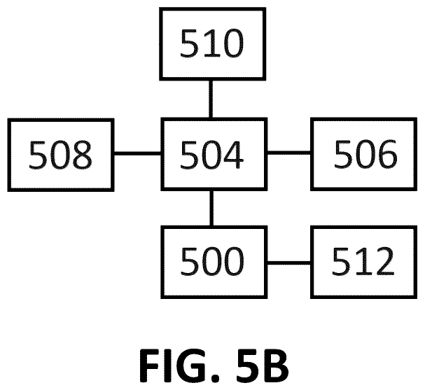

FIG. 5A shows a perspective view of an internal portion of an exemplary sport simulation system 100 of the present disclosure. As shown therein, a ball tracking device 500 is mounted on a ceiling 502 of box 104 of box truck 106 is configured to identify golf ball or baseball (or other ball) trajectories and speed in connection with simulated golf or baseball shots after impact. A track mechanism 504 within box 104 can allow the ball tracking device 500 to be mounted on the ceiling 502 and travel to achieve different hitting directions. Such a recessed track mechanism 504 can be constructed from high-strength materials like aluminum or steel alloys, integrated into the ceiling 502 structure. Track mechanism 504 can also permit ball tracking device 500 to swivel so that it can operate to track balls regardless of the location(s) of projection screen(s) 300, such as at one or more of a driver-side, passenger-side, or front of box 104 of box truck 106. Precision bearing wheels 506, and an anti-sway mechanism 508, and motorized movement (from track motor 510), such as shown in the block diagram of FIG. 5B, ensure smooth operation and stability. The Trackman unit includes automatic calibration, integrated data collection, wireless connectivity, and data storage for comprehensive training and analysis. Safety sensors 512, maintenance alerts, and a user-friendly interface enhance the system's functionality and user experience.

Interior lighting 520 and strategically placed speakers 522, such as shown in FIG. 5A, can enhance the immersive experience. The simulator can be equipped with adjustable, color-changing LED lighting 520 controlled via the smart hub 312, allowing users to adjust brightness and color to match their preferences or external conditions. The sound system 524 features strategically placed speakers 522 to deliver surround sound, enhancing the immersive experience. The sound system 524 can include a combination of ceiling-mounted and wall-mounted speakers 522, providing even sound distribution. The sound system 524 can support high-fidelity audio and can be synchronized with the visual content, ensuring users are fully engaged.

Furthermore, and as shown in FIG. 5A, an exemplary sport simulation system 100 of the present disclosure can have impact padding 550 applied to at least one internal wall of the box 104 of the box truck 106.

A leveling system (actuators 206) can be incorporated into various system 100 embodiments to level the unit (box 104) and change the angle of hit/putt as may be desired. The leveling system consists of automatic, adjustable jacks (actuators 206) controlled via the smart hub 312. The smart hub 312 interface coordinates with various sensors and feedback mechanisms 350, including but not limited to inclinometers, load sensors, position sensors, and hydraulic pressure sensors, to ensure precise leveling and safe operation. Automated adjustments, manual overrides, predictive maintenance, real-time alerts, fail-safe mechanisms, data logging, and remote monitoring (all additional exemplary sensors and feedback mechanisms 350) enhance the system's functionality and reliability.

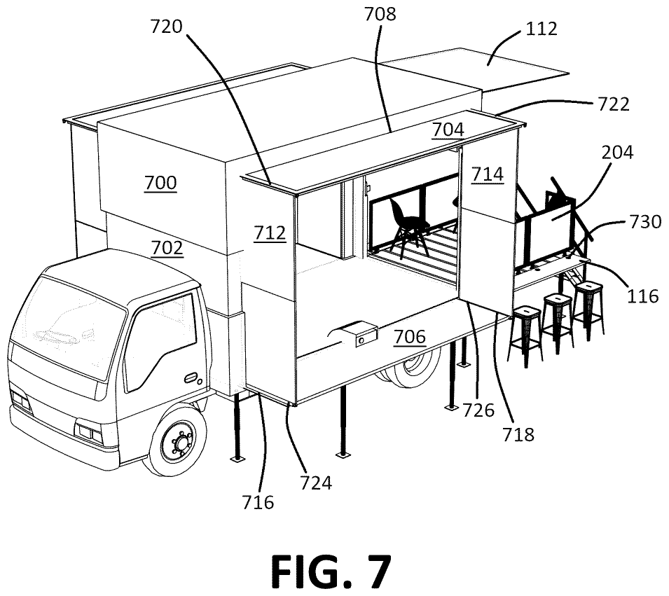

Driver-side fold-out 102 and passenger-side fold-out 108 each fold out to convert the box 104 of box truck 106 into a larger, more useful space for simulated sports to take place. For example, and as shown in FIG. 7, to expand the box 104 vertically, upper box portion 700 moves upward, exposing outer box wall 702. Upper extension panel 704 and lower extension panel 706, on each side of box 104, when in a closed configuration form the overall outer sides of box 104 of box truck. When in an open configuration, such as shown in FIG. 7, upper extension panel 704 opens outward from the top of box 104 (at hinge location 708), and lower extension panel 706 opens outward from the bottom of box 104 (at hinge location 710). To form the expanded front and rear walls of box 104, front panel 712 and rear panel 714 unfold upward from hinges 716, 718 to form said walls.

The folding sides (upper extension panel 704, lower extension panel 706, front panel 712, and rear panel 714) are engineered with robust hinges 708, 710, 716, 718 and locking mechanisms 720, 722 to ensure stability and safety. Constructed from strong, durable aluminum or steel framing, the extended sides provide ample space for a full golf swing and create a spacious interior environment of box 104. Additionally, these sides can be equipped with weather-resistant seals 724, 726 to maintain a comfortable indoor atmosphere. The folding mechanism can utilize gas pistons or motors for quick and effortless setup, allowing for rapid deployment and retraction. Built-in supports are deployed when the unit is in use, allowing the folding sides to act as stages, increasing the usable interior space.

A lounge area of system 100, such as shown in FIG. 7, can feature railing inserts (sidewalls 204) and folding bar tops 116 with optional integrated cup holders 730. The lounge area is designed for user comfort, with modular railing inserts (sidewalls 204) that can be quickly assembled or disassembled. The folding bar tops 116 are crafted from durable materials and can include built-in cup holders 730 as noted above, providing a convenient and social space for users to relax between sessions. Additional features may include storage compartments (not shown) and customizable seating (using chairs or stools 118) arrangements to enhance usability and comfort.

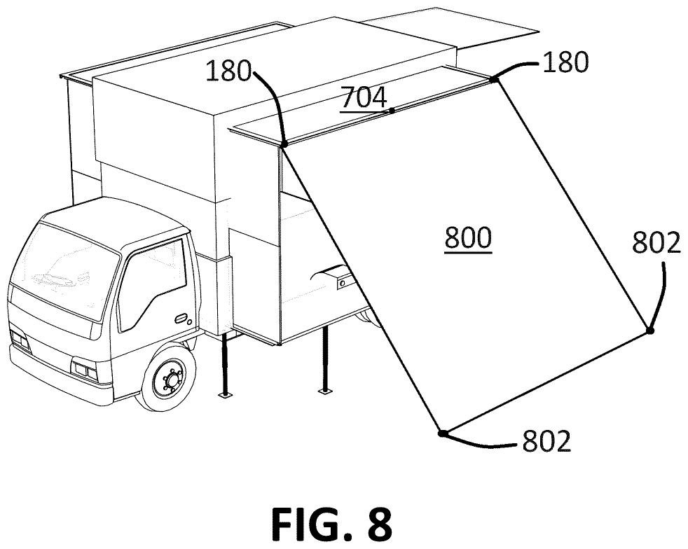

FIG. 8 shows an embodiment of a system 100 of the present disclosure whereby an extension screen 800 can be used (as part of system 100), extending from upper extension panel 704 to the ground at an angle. Such a configuration allows users to stand underneath extension screen 800 in the event of rain, snow, or excessive sunlight. Extension screen can extend from ring anchor points 180 to the ground, held in place by ground securing apparatuses 802.

While various embodiments of devices, systems, and methods have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A sport simulation system, comprising:
a box truck comprising a box;
a driver-side fold-out configured to extend laterally from the box on a first side; and
a passenger-side fold-out configured to extend laterally from the box on a second side opposite the first side;
wherein an interior of the box is configured as a sport simulator with a projection screen.

2. The sport simulation system of claim 1, further comprising:
a retractable canopy configured to extend outward from a rear of the box.

3. The sport simulation system of claim 1, further comprising:
a rear platform extending outward from a rear of the box, the rear platform accessible from a ground by way of stairs.

4. The sport simulation system of claim 3, further comprising:
one or more bar tops coupled to the rear platform.

5. The sport simulation system of claim 1, further comprising:
a plurality of actuators extending downward from the box truck and configured to level or otherwise manipulate an angle of the box of the box truck.

6. The sport simulation system of claim 5, further comprising:
a smart hub configured to control operation of the plurality of actuators and further configured to control operation of the projection screen.

7. The sport simulation system of claim 1, further comprising:
a first projector coupled to an internal floor of the box, the first projector configured to project a first image onto the projection screen.

8. The sport simulation system of claim 7, further comprising:
a second projector coupled to an internal floor of the box, the second projector configured to project a second image onto a second projection screen in a direction opposite the projection of the first image onto the projection screen.

9. The sport simulation system of claim 1, further comprising:
a ball tracking device coupled to an internal ceiling of the box, the ball tracking device configured to detect a speed and an angle of a ball hit toward the projection screen.

10. The sport simulation system of claim 1, wherein the driver-side fold-out and the passenger-side fold-out each comprise an upper extension panel and a lower extension panel, wherein the upper extension panel forms an extended ceiling for the box of box truck, and wherein the lower extension panel forms an extended floor for the box of the box truck.

11. The sport simulation system of claim 10, wherein the driver-side fold-out and the passenger-side fold-out each comprise a front panel and a rear panel, each configured to fold upward from the lower extension panel.

12. The sport simulation system of claim 1, wherein the box of the box truck comprises an upper box portion configured to extend upward to increase an internal height of the box.

13. The sport simulation system of claim 10, further comprising:
an impact screen positioned in front of or behind the projection screen.

14. The sport simulation system of claim 13, wherein the impact screen and the projection screen are integrated with the upper extension panel and the lower extension panel.

15. The sport simulation system of claim 1, further comprising:
a first projector coupled to an internal floor of the box, the first projector configured as a multi-layer projector configured to project a multi-layer image onto the projection screen.

16. The sport simulation system of claim 1, wherein at least one internal wall of the box of the box truck has impact padding applied thereto.
